(19) United States
(12) Patent Application Publication
(10) Pub. No.: US 2026/0179613 A1
(43) Pub. Date: Jun. 25, 2026

(54) PROCESSING APPARATUS, PROCESSING METHOD, AND NON-TRANSITORY COMPUTER-READABLE MEDIUM

(71) Applicant: NEC Corporation, Minato-ku, Tokyo (JP)

(72) Inventors: Shuji KOMEIJI, Tokyo (JP); Akira GOTOH, Tokyo (JP); Yuka KUGA, Tokyo (JP); Yuko NAKANISHI, Tokyo (JP)

(73) Assignee: NEC Corporation, Minato-ku, Tokyo (JP)

(21) Appl. No.: 19/124,344

(22) PCT Filed: Nov. 6, 2023
(86) PCT No.: PCT/JP2023/039839

§ 371 Date: Apr. 25, 2025

(30) Foreign Application Priority Data
Nov. 24, 2022 (JP) 2022-187196

(51) Int. Cl. G10L 15/22; G10L 13/00; G10L 15/02; G10L 15/065; G10L 15/07; G10L 15/187; G10L 15/26

(52) U.S. Cl. CPC G10L 15/22; G10L 13/00; G10L 15/02; G10L 15/065; G10L 15/07; G10L 15/187; G10L 15/26; G10L 2015/223

(57) ABSTRACT

The present invention provides a processing apparatus (10) including: an acquisition unit (11) that acquires speech data to be recognized; a recognition unit (12) that inputs the speech data to be recognized to a speech recognition model, and acquires recognition result text data indicating a content of the speech data to be recognized; an output unit (13) that outputs the recognition result text data; a user input reception unit (16) that receives a user input of corrected text data indicating a correct content of an erroneously recognized part included in the recognition result text data; a sound data generation unit (15) that generates synthetic sound data uttering a content of the corrected text data; and a training unit (14) that retrains the speech recognition model by using learning data in which the corrected text data and the synthetic sound data are associated with each other.

### TECHNICAL FIELD

The present invention relates to a processing apparatus, a processing method, and a program.

### BACKGROUND ART

Techniques relating to the present invention are disclosed in Patent Documents 1 and 2.

Patent Document 1 discloses a technique for performing speech recognition processing for input speech data, displaying text data being a result of the processing, and receiving a user input for specifying an erroneous part in the text data and correcting the specified erroneous part to a correct content.

Further, Patent Document 1 discloses a technique for retraining, based on corrected text data and input speech data, a speech recognition model, performing speech recognition processing by inputting again the input speech data to the retrained speech recognition model, and displaying text data being a result of the processing.

Patent Document 2 discloses a technique for performing speech recognition processing for input speech data, displaying text date being a result of the processing, receiving a user input of a correct answer character string being a correct content of an erroneous part included in the text data, generating speech data from the correct answer character string, and determining, by using the generated speech data, the erroneous part in the text data.

### RELATED DOCUMENT

### Patent Document

Patent Document 1: Japanese Patent Application Publication No. 2014-134640
Patent Document 2: Japanese Patent Application Publication No. 2006-267319

### SUMMARY

### Technical Problem

In various applications such as meeting minutes preparation, speech recognition processing is used. However, accuracy of speech recognition processing is not 100%, and therefore correction work for an erroneous part included in text data acquired by the speech recognition processing is required.

In a case of the technique described in Patent Document 1, it is necessary to receive, from a user, an input for specifying an erroneous part in text data being a speech recognition result and an input for correcting the erroneous part to a correct content. Some users feel cumbersome in input for specifying an erroneous part in text data.

Further, in the case of the technique described in Patent Document 1, a speech recognition model is retrained by using input speech data as learning data. In this case, processing of cutting out speech data of an erroneous part from the input speech data and the like is required, and thereby a large amount of time is required. As a result, there is a problem in that a waiting time of a user until acquisition of a recognition result after retraining is increased.

In the technique described in Patent Document 2, while a recognition result itself acquired this time can be corrected, a speech recognition model is not corrected. Therefore, also in a future, a similar recognition mistake may occur. As a result, a user needs to repeat the correction processing many times.

In view of the above-described problems, one example of an object of the present invention is to provide a processing apparatus, a processing method, and a program that solve an issue in that workability of correction work for an erroneous part included in text data acquired by speech recognition processing is improved.

### Solution to Problem

According to one example aspect of the present invention, provided is a processing apparatus including:
an acquisition unit that acquires speech data to be recognized;
a recognition unit that inputs the speech data to be recognized to a speech recognition model, and acquires recognition result text data indicating a content of the speech data to be recognized;
an output unit that outputs the recognition result text data;
a user input reception unit that receives a user input of corrected text data indicating a correct content of an erroneously recognized part included in the recognition result text data;
a sound data generation unit that generates synthetic sound data uttering a content of the corrected text data; and
a training unit that retrains the speech recognition model by using learning data in which the corrected text data and the synthetic sound data are associated with each other.

According to one example aspect of the present invention, provided is a processing method including:
by one or more computers,
   acquiring speech data to be recognized;
   inputting the speech data to be recognized to a speech recognition model, and acquiring recognition result text data indicating a content of the speech data to be recognized;
   outputting the recognition result text data;
   receiving a user input of corrected text data indicating a correct content of an erroneously recognized part included in the recognition result text data;
   generating synthetic sound data uttering a content of the corrected text data; and
   retraining the speech recognition model by using learning data in which the corrected text data and the synthetic sound data are associated with each other.

According to one example aspect of the present invention, provided is a program causing a computer to function as:
an acquisition unit that acquires speech data to be recognized;
a recognition unit that inputs the speech data to be recognized to a speech recognition model, and acquires recognition result text data indicating a content of the speech data to be recognized;
an output unit that outputs the recognition result text data;
a user input reception unit that receives a user input of corrected text data indicating a correct content of an erroneously recognized part included in the recognition result text data;
a sound data generation unit that generates synthetic sound data uttering a content of the corrected text data; and
a training unit that retrains the speech recognition model by using learning data in which the corrected text data and the synthetic sound data are associated with each other.

### Advantageous Effects of Invention

According to one example aspect of the present invention, achieved are a processing apparatus, a processing method, and a program that solve an issue in that workability of correction work for an erroneous part included in text data acquired by speech recognition processing is improved.

### BRIEF DESCRIPTION OF THE DRAWINGS

The above-described object, other objects, features, and advantages will become more apparent from public example embodiments described below and the following accompanying drawings.

FIG. 1 It is a diagram illustrating one example of a function block diagram of a processing apparatus.

FIG. 2 It is a diagram illustrating one example of a processing content of the processing apparatus.

FIG. 3 It is a diagram illustrating one example of a hardware configuration of the processing apparatus.

FIG. 4 It is a flowchart illustrating one example of a flow of processing of the processing apparatus.

FIG. 5 It is a diagram illustrating one example of a screen output by the processing apparatus.

FIG. 6 It is a diagram illustrating one example of a screen output by the processing apparatus.

FIG. 7 It is a flowchart illustrating one example of a flow of processing of the processing apparatus.

FIG. 8 It is a flowchart illustrating one example of a flow of processing of the processing apparatus.

### EXAMPLE EMBODIMENT

Hereinafter, example embodiments according to the present invention are described by using the accompanying drawings. Note that, in all drawings, a similar component is assigned with a similar reference sign, and description thereof is omitted as appropriate.

### First Example Embodiment

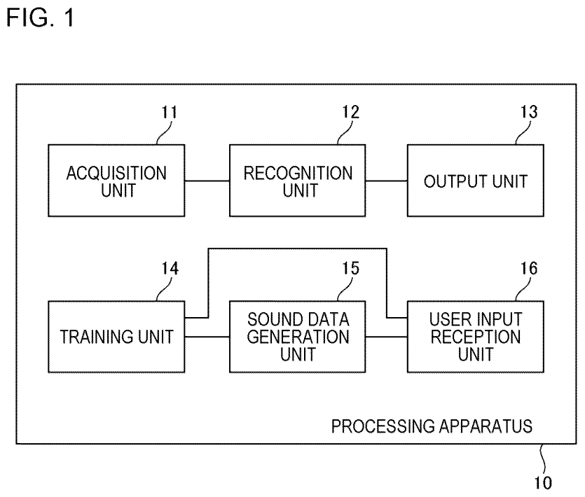

FIG. 1 is a function block diagram illustrating an outline of a processing apparatus 10 according to a first example embodiment. The processing apparatus 10 includes an acquisition unit 11, a recognition unit 12, an output unit 13, a training unit 14, a sound data generation unit 15, and a user input reception unit 16.

The acquisition unit 11 acquires speech data to be recognized. The recognition unit 12 inputs the speech data to be recognized to a speech recognition model, and acquires recognition result text data indicating a content of the speech data to be recognized. The output unit 13 outputs the recognition result text data. The user input reception unit 16 receives a user input of corrected text data indicating a correct content of an erroneously recognized part included in the recognition result text data. The sound data generation unit 15 generates synthetic sound data uttering a content of the corrected text data. The training unit 14 retrains the speech recognition model by using learning data in which the corrected text data and the synthetic sound data are associated with each other.

According to the processing apparatus 10 including such a configuration, a user needs only to input corrected text data indicating a correct content of an erroneously recognized part included in recognition result text data, and does not need to perform input for specifying an erroneously recognized part in recognition result text data.

Further, according to the processing apparatus 10 of the present example embodiment, a speech recognition model itself is correctly retrained, and therefore, thereafter, similar erroneous recognition is unlikely to occur. Therefore, inconvenience in which a user repeatedly performs correction work for similar erroneous recognition can be reduced.

Further, according to the processing apparatus 10 of the present example embodiment, from corrected text data, synthetic sound data are generated, and a speech recognition model is retrained by using the synthetic sound data as learning data. Therefore, compared with a case where a predetermined part is determined in speech data to be recognized, and the predetermined part is cut out and designated as learning data, a time until completion of retraining can be shortened. As a result, a waiting time of a user until acquisition of a recognition result after retraining can be shortened.

In this manner, according to the processing apparatus 10 of the present example embodiment, workability of correction work for an erroneous part included in text data acquired by speech recognition processing can be improved.

### Second Example Embodiment

### “Outline”

A processing apparatus 10 according to a second example embodiment is embodied more than the processing apparatus 10 according to the first example embodiment.

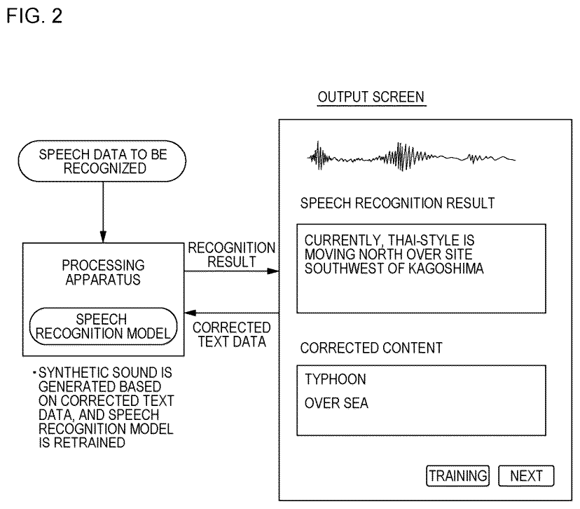

As illustrated in FIG. 2, the processing apparatus 10 acquires speech data to be recognized, then inputs the speech data to be recognized to a speech recognition model, and acquires recognition result text data indicating a content of the speech data to be recognized. Then, the processing apparatus 10 outputs the recognition result text data. The processing apparatus 10 generates an output screen, for example, as illustrated, and outputs the generated output screen toward a user. In a “speech recognition result” field on the illustrated output screen, recognition result text data are displayed.

Thereafter, the processing apparatus 10 receives a user input of corrected text data indicating a correct content of an erroneously recognized part included in the recognition result text data. In a case of the illustrated example, a user inputs corrected text data indicating a correct content of the erroneously recognized part in a “corrected content” field of the output screen. In an illustrated speech recognition result, from an anteroposterior context, it is understood that two parts being “Thai-style” and “site” are relevant to erroneous recognition. A user inputs, as illustrated, “typhoon” and “over the sea” each being correct contents of the two erroneously recognized parts. Note that, a user does not need to perform input for specifying erroneously recognized parts (Thai-style and site) in recognition result text data displayed in the speech recognition result field. Further, a user does not need to perform input for specifying to what erroneously recognized part of recognition result text data displayed in the speech recognition result field two pieces of corrected text data input to the corrected content field are relevant.

Thereafter, the processing apparatus 10 generates synthetic sound data uttering a content of the corrected text data input to the corrected content field. Then, the processing apparatus 10 retrains the speech recognition model by using learning data in which the corrected text data and the synthetic sound data are associated with each other. Based on retraining specialized for the erroneously recognized part, it is expected that the erroneously recognized part can be correctly recognized.

After the retraining is finished, a user operates the processing apparatus 10, and thereby, can cause again speech recognition processing using the retrained speech recognition model, i.e. the speech recognition model in which the erroneously recognized part can be correctly recognized to be executed for the speech data to be recognized. As a result, a user can acquire a speech recognition result in which the erroneously recognized part is correctly corrected. Note that, herein, an example in which speech recognition processing using a speech recognition model after retraining is executed based on a manual operation by a user has been described, but according to another example embodiment, an example in which speech recognition processing using a speech recognition model after retraining is automatically executed is described.

Hereinafter, a configuration of the processing apparatus 10 is described in detail.

### “Hardware Configuration”

Next, one example of a hardware configuration of the processing apparatus 10 is described. Each function unit of the processing apparatus 10 is achieved by any combination of hardware and software. It is understandable to those skilled in the art that an achievement method therefor and an apparatus include various modified examples. The software includes a program previously stored from a stage where an apparatus is shipped, a program and the like downloaded from a medium such as a compact disc (CD) and a server and the like on the Internet.

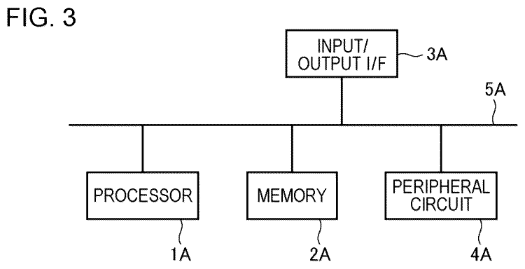

FIG. 3 is a block diagram illustrating a hardware configuration of the processing apparatus 10. As illustrated in FIG. 3, the processing apparatus 10 includes a processor 1A, a memory 2A, an input/output interface 3A, a peripheral circuit 4A, and a bus 5A. The peripheral circuit 4A includes various modules. The processing apparatus 10 may not necessarily include the peripheral circuit 4A. Note that, the processing apparatus 10 may be configured by using a plurality of apparatuses physically and/or logically separated. In this case, each of the plurality of apparatuses may include the above-described hardware configuration.

The bus 5A is a data transmission path through which the processor 1A, the memory 2A, the peripheral circuit 4A, and the input/output interface 3A mutually transmit/receive data. The processor 1A is an arithmetic processing apparatus, for example, such as a CPU and a graphics processing unit (GPU). The memory 2A is a memory, for example, such as a random access memory (RAM) and a read only memory (ROM). The input/output interface 3A includes an interface for acquiring information from an input apparatus, an external apparatus, an external server, an external sensor, a camera, and the like, an interface for outputting information to an output apparatus, an external apparatus, an external server, and the like, and the like. Further, the input/output interface 3A includes an interface for connection to a communication network such as the Internet. The input apparatus is, for example, a keyboard, a mouse, a microphone, a physical button, a touch panel, or the like. The output apparatus is, for example, a display, a speaker, a printer, a mailer, or the like. The processor 1A can issue an instruction to each module, and perform an operation, based on operation results of the modules.

### “Function Configuration”

Next, a function configuration of the processing apparatus 10 according to the second example embodiment is described in detail. FIG. 1 illustrates one example of a function block diagram of the processing apparatus 10. As illustrated, the processing apparatus 10 includes an acquisition unit 11, a recognition unit 12, an output unit 13, a training unit 14, a sound data generation unit 15, and a user input reception unit 16.

The acquisition unit 11 acquires speech data to be recognized. The speech data to be recognized are speech data being a target for speech recognition processing. For example, speech data in which various types of speeches such as a conference, a call, a meeting, and a dialog are recorded become speech data to be recognized.

According to example embodiments, “acquisition” includes at least one of a matter that a local apparatus fetches data or information stored in another apparatus or a storage medium (active acquisition), and a mater that data or information output from another apparatus are input to a local apparatus (passive acquisition). Examples of the active acquisition include a matter that a request or an inquiry is issued to another apparatus and a reply thereof is received, a matter that reading is executed by accessing another apparatus or a storage medium, and the like. Further, examples of the passive acquisition include a matter that information distributed (transmitted, push-notified, or the like) is received, and the like. Furthermore, the “acquisition” may be a matter that selective acquisition is executed from among pieces of received data or information, or a matter that selective reception is executed from among pieces of distributed data or information.

The recognition unit 12 inputs speech data to be recognized to a speech recognition model, and acquires recognition result text data indicating a content of the speech data to be recognized.

The speech recognition model is configured in such a way as to receive input of speech data, then execute speech recognition processing for the speech data, and output, as a recognition result, recognition result text data indicating a content (utterance content) of the speech data. The speech recognition model is a model previously trained based on learning data in which text data and speech data uttering the text data are associated with each other. A learning method is not specifically limited, and every well-known method is employable.

The output unit 13 outputs recognition result text data. The output unit 13 generates and outputs, for example, an output screen as illustrated in FIG. 2.

The output screen illustrated in FIG. 2 includes a field for displaying a speech waveform, a speech recognition result field, and a corrected content field.

The output unit 13 displays, in the field for displaying a speech waveform, a speech waveform of speech data to be recognized.

Further, the output unit 13 displays, in the speech recognition result field, recognition result text data.

Further, the output unit 13 displays, in the corrected content field, a character string input by a user, specifically, corrected text data indicating a correct content of an erroneously recognized part included in recognition result text data. The user input is achieved by the user input reception unit 16 described below.

In a case of the output screen in FIG. 2, in a case where a “training” button is depressed, retraining for a speech recognition model based on corrected text data input to the corrected content field at that time is executed. The retraining is achieved by the training unit 14 and the sound data generation unit 15 described below.

Note that, the output screen further includes another configuration. For example, a “reproduction” button may be included. In a case where the “reproduction” button is depressed, speech data to be recognized are reproduced. In this case, a user can confirm, while viewing a speech, recognition result text data, and detect an erroneously recognized part.

In addition, the output screen may include a user interface (UI) component for specifying a reproduction part. It is convenient that, in a case where speech data to be recognized are large, the UI component is available. As such a UI component, for example, a slider and a UI component capable of directly inputting an elapsed time from start are exemplified. For example, a user specifies, as a reproduction part, a part where a speech recognition result in speech data to be recognized is intended to be confirmed. According to the specification, in the speech recognition result field, a speech recognition result of the part is displayed. Further, according to depression of the “reproduction” button, a part specified in the speech data to be recognized is reproduced.

There are various output forms based on an output screen as described above. The output unit 13 may display, for example, an output screen on a display included in the processing apparatus 10. In addition, the processing apparatus 10 may be a server. In this case, the processing apparatus 10 receives, from a client terminal, an input of speech data to be recognized, and transmits an output screen back to the client terminal. Then, the output screen is displayed on a display of the client terminal.

Referring back to FIG. 1, the user input reception unit 16 receives a user input of corrected text data indicating a correct content of an erroneously recognized part included in recognition result text data. The corrected text data may be a word, or may be text. Note that, the user input reception unit 16 does not receive input for specifying an erroneously recognized part included in recognition result text data.

There are various means that receive a user input of corrected text data, and one example is described below. The user input reception unit 16 can receive a user input of corrected text data, for example, via the corrected content field of the output screen illustrated in FIG. 2. A user confirms whether there is an erroneously recognized part in recognition result text data displayed in the speech recognition result field of the output screen. At that time, a user may reproduce speech data to be recognized. Then, a user inputs, in a case where an erroneously recognized part is found, corrected text data indicating a correct content of the erroneously recognized part in the corrected content field.

In the case of the example in FIG. 2, from an anteroposterior context, it is understood that two parts being “Thai-style” and “site” are relevant to erroneous recognition. A user inputs, as illustrated, “typhoon” and “over the sea” each being correct contents of the two erroneously recognized parts. Note that, a user does not need to perform input for specifying erroneously recognized parts (Thai-style and site) in recognition result text data displayed in the speech recognition result field. Further, a user does not need to perform input for specifying to what erroneously recognized part of recognition result text data displayed in the speech recognition result field two pieces of corrected text data input to the corrected content field are relevant.

Further, the corrected text data need only to include at least a correct content of an erroneously recognized part, and the content has a degree of freedom to some extent. For example, corrected text data input for erroneous recognition being “Thai-style” may be “typhoon”, or may be text indicated by recognition result text data being “Currently, a typhoon is moving north over the sea southwest of Kagoshima.”. In addition, a user may freely make an expression or text including a correct content (typhoon) of an erroneously recognized part (Thai-style) as in “typhoon season” and “A typhoon is moving north.”, and input the made expression or text as corrected text data.

Referring back to FIG. 1, the sound data generation unit 15 generates synthetic sound data uttering a content of corrected text data. A generation method for the synthetic sound data is not specifically limited, and every well-known technique is usable. Reading of a kanji character included in the corrected text data may be determined based on dictionary data, may be determined based on a content of a user input at an input time of corrected text data, or may be determined by another method.

The training unit 14 retrains a speech recognition model, by using learning data in which the corrected text data and the synthetic sound data are associated with each other. A method for retraining is not specifically limited, and every well-known method is employable. Based on the retraining specialized for an erroneously recognized part, it is expected that the erroneously recognized part can be correctly recognized.

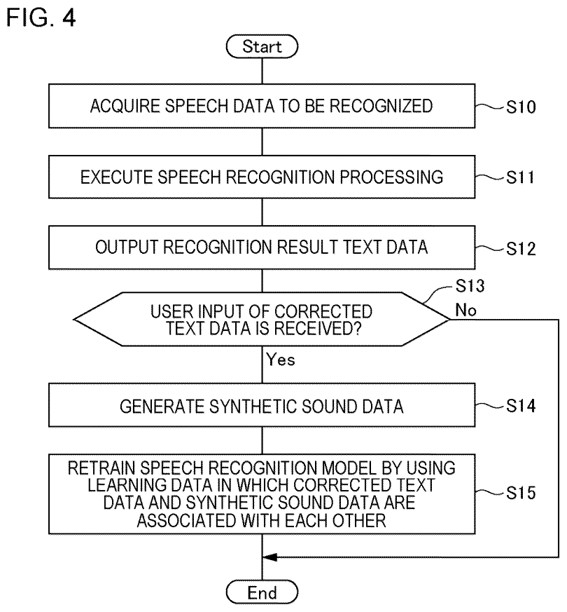

Next, by using a flowchart in FIG. 4, one example of a flow of processing of the processing apparatus 10 is described.

First, the processing apparatus 10 acquires speech data to be recognized (S10), and then executes speech recognition processing for the speech data to be recognized (S11). Specifically, the processing apparatus 10 inputs speech data to be recognized to a previously-prepared speech recognition model, and acquires recognition result text data indicating a content of the speech data to be recognized.

Next, the processing apparatus 10 outputs the recognition result text data indicating a result of the speech recognition processing for the speech data to be recognized (S12). The processing apparatus 10 outputs, for example, an output screen illustrated in FIG. 2.

Thereafter, the processing apparatus 10 receives a user input of corrected text data indicating a correct content of an erroneously recognized part included in the recognition result text data (Yes in S13), and then generates synthetic sound data uttering a content of the corrected text data (S14). Then, the processing apparatus 10 retrains the speech recognition model by using learning data in which the corrected text data and the synthetic sound data are associated with each other (S15).

After the retraining is finished, a user operates the processing apparatus 10, and thereby, can cause again speech recognition processing using the retrained speech recognition model, i.e. the speech recognition model in which the erroneously recognized part can be correctly recognized to be executed for the speech data to be recognized. As a result, a user can acquire a speech recognition result in which the erroneously recognized part is correctly corrected.

Herein, a specific example in which Yes is decided in S13, i.e. a trigger for starting “generating a synthetic sound (S14)” and “retraining (S15)” is described.

As one example, as illustrated in FIG. 2, an output screen may include a “training” button. In this case, the processing apparatus 10 can decide, in a case where the “training” button is depressed in a state where corrected text date are input in a corrected content field, that a “user input of corrected text data is received (Yes in S13)”. In this case, all pieces of text input to the corrected content field at that time can be processed as corrected text data.

As another example, the processing apparatus 10 can decide, in a case where a predetermined input operation is performed in the corrected content field in a state where corrected text data are input in the corrected content field, that a “user input of corrected text data is received (Yes in S13)”. The “predetermined input operation in the corrected content field” is, for example, line feed, input of a punctuation mark, input of a space, or the like. In this case, text input immediately before of a target (line feed, a punctuation mark, a space, or the like) input by the predetermined input operation can be processed as corrected text data.

### “Advantageous Effect”

According to the processing apparatus 10 of the present example embodiment, an advantageous effect similar to that of the first example embodiment is achieved.

Further, according to the processing apparatus 10 of the present example embodiment, a content of corrected text data input by a user has a degree of freedom, and at least a correct content of an erroneously recognized part needs only to be included. According to the processing apparatus 10 of the present example embodiment as described above, by using expressions and text of various patterns, retraining relating to an erroneously recognized part can be executed. As a result, an effect of retraining can be improved.

Further, according to the processing apparatus 10 of the present example embodiment, at various pieces of timing, retraining can be started. For example, retraining can be executed by using, as a trigger, a fact that a predetermined input operation is performed in the corrected content field in a state where corrected text data are input in the corrected content field. The “predetermined input operation in the corrected content field” is, for example, line feed, input of a punctuation mark, input of a space, or the like. In this case, retraining can be executed in real time, in parallel to input of corrected text data by a user. As a result, a waiting time of a user can be reduced.

### Third Example Embodiment

A processing apparatus 10 according to the present example embodiment includes a function for retraining a speech recognition model, then automatically inputting speech data to be recognized to the speech recognition model after retraining, and outputting a recognition result based on the retrained model to a user. Hereinafter, detailed description is made.

A recognition unit 12 inputs, after retaining of a speech recognition model based on a training unit 14 is finished, speech data to be recognized to the speech recognition model after subjected to retraining, and acquires recognition result text data after retraining indicating a content of the speech data to be recognized. The speech data to be recognized input to the speech recognition model after subjected to retraining are speech data to be recognized that are input to the speech recognition model before subjected to retraining and include, in a speech recognition result based on the model, an erroneously recognized part.

An output unit 13 outputs recognition result text data after retraining. The output unit 13 executes processing of outputting recognition result text data and recognition result text data after retraining side by side, or processing of updating a content in a field for displaying a speech recognition result from recognition result text data (a recognition result acquired by a speech recognition model before subjected to retaining) to recognition result data after retraining (a recognition result acquired by a speech recognition model after subjected to retraining).

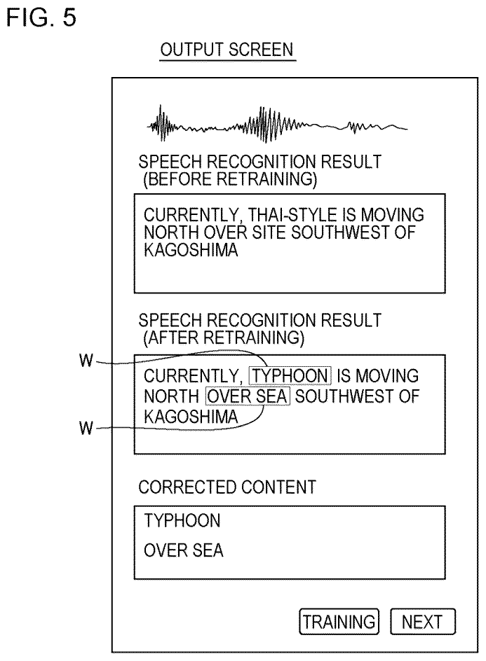

The output unit 13 can output, for example, an output screen as illustrated in FIG. 5 according to speech recognition processing using a speech recognition model after subjected to retaining. In the output screen in FIG. 5, recognition result text data and recognition result text data after retraining are displayed side by side. In a “speech recognition result (before retraining)” field, the recognition result text data are displayed. And, in a “speech recognition result (after retraining)” field, the recognition result text data after retraining are displayed.

As illustrated, the output unit 13 may detect a different portion between the recognition result text data and the recognition result text data after retraining, and emphasize the detected different portion in output of the recognition result text data after retraining. The detection of a different portion is achieved by comparison processing between the recognition result text data and the recognition result text data after retraining. In the illustrated example, while a different portion is surrounded by a frame W and emphasis is performed, emphasis may be performed based on another method of changing a thickness of a character, changing color, or the like.

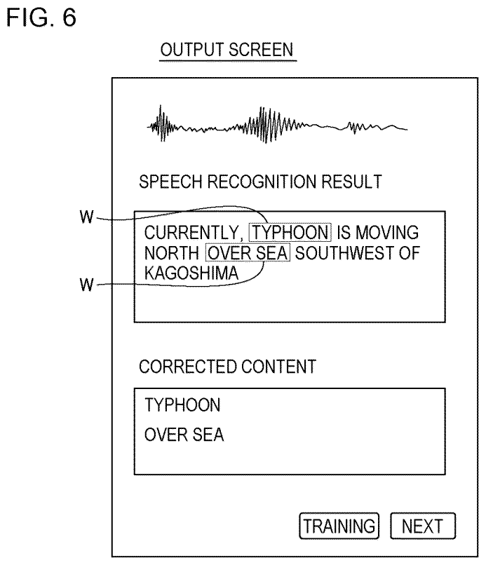

As another example, the output unit 13 can output an output screen as illustrated in FIG. 6 according to speech recognition processing using a speech recognition model after subjected to retraining. In the output screen in FIG. 6, in the speech recognition result field, recognition result text data after retraining are displayed. In other words, a display content in the speech recognition result field is switched from recognition result text data acquired by speech recognition processing using a speech recognition model before retraining to recognition result text data after retraining acquired by speech recognition processing using a speech recognition model after retraining.

Also, in the example, the output unit 13 may detect, as illustrated, a different portion between the recognition result text data and the recognition result text data after retraining, and emphasize the detected different portion in output of the recognition result text data after retraining.

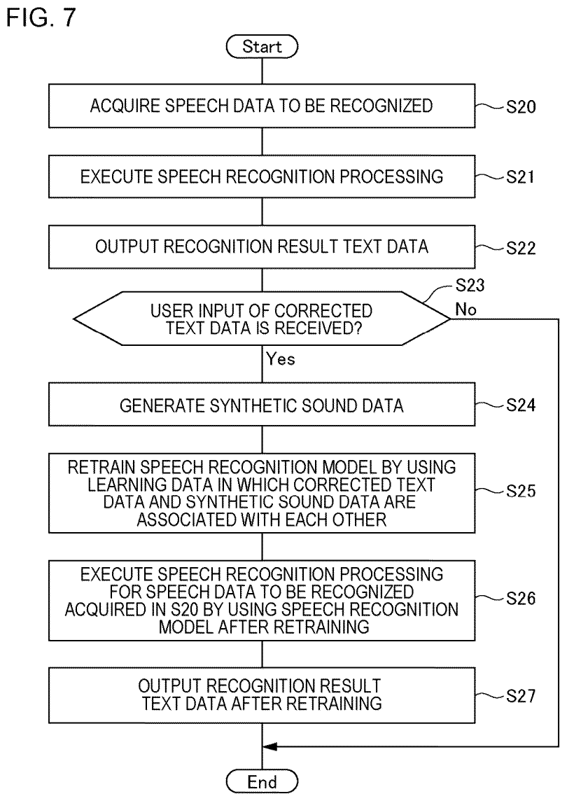

Next, by using a flowchart in FIG. 7, one example of a flow of processing of the processing apparatus 10 is described.

First, the processing apparatus 10 acquires speech data to be recognized (S20), and then executes speech recognition processing for the speech data to be recognized (S21). Specifically, the processing apparatus 10 inputs speech data to be recognized in a previously-prepared speech recognition model, and acquires recognition result text data indicating a content of the speech data to be recognized.

Next, the processing apparatus 10 outputs the recognition result text data indicating a result of the speech recognition processing for the speech data to be recognized (S22). The processing apparatus 10 outputs, for example, an output screen illustrated in FIG. 2.

Thereafter, the processing apparatus 10 receives a user input of corrected text data indicating a correct content of an erroneously recognized part included in the recognition result text data (Yes in S23), and then generates synthetic sound data uttering a content of the corrected text data (S24). Then, the processing apparatus 10 retrains the speech recognition model by using learning data in which the corrected text data and the synthetic sound data are associated with each other (S25).

Thereafter, the processing apparatus 10 executes speech recognition processing for the speech data to be recognized acquired in S20 by using the speech recognition model after subjected to retraining (S26). Specifically, the processing apparatus 10 inputs the speech data to be recognized acquired in S20 to the speech recognition model after subjected to retraining, and acquires recognition result text data after retraining indicating a content of the speech data to be recognized.

Next, the processing apparatus 10 outputs the recognition result text data after retraining (S27). The processing apparatus 10 executes, for example, processing of outputting the recognition result text data and the recognition result text data after retraining side by side as illustrated in FIG. 5, or processing of updating a content in a field for displaying a speech recognition result from the recognition result text data to the recognition result text data after retraining as illustrated in FIG. 6.

Another configuration of the processing apparatus 10 according to the present example embodiment is similar to that of the first and second example embodiments.

According to the processing apparatus 10 of the present example embodiment, an advantageous effect similar to that of the first and second example embodiments is achieved.

Further, according to the processing apparatus 10 of the present example embodiment, after a speech recognition model is retrained, speech data to be recognized are automatically input to the speech recognition model after retraining, and thereby, a recognition result based on the input can be output toward a user. A user only inputs corrected text data indicating a correct content of an erroneously recognized part included in recognition result text data, and thereby, can acquire recognition result text data after retraining in which the erroneously recognized part is correctly corrected.

Further, according to the processing apparatus 10 of the present example embodiment, at a time when recognition result text data after retraining are displayed toward a user, a different point between recognition result text data acquired based on a speech recognition model before retraining and recognition result text data after retraining acquired based on a speech recognition model after retraining can be emphasized. Based on the emphasis, a user can easily recognize a part changed according to retraining. As a result, a user can easily recognize whether an erroneously recognized part is correctly corrected by retraining, whether a content of a part not relating to an erroneously recognized part is changed by retraining, and the like.

### Fourth Example Embodiment

A processing apparatus 10 according to the present example embodiment includes a function for executing retraining again (twice-repeatedly retraining) for a speech recognition model, in a case where an erroneously recognized part is not correctly corrected by retraining. Then, the processing apparatus 10 includes a function for training a speech recognition model by a method different from a method at a time of retraining, at a time when the speech recognition model is subjected to twice-repeated retraining. Hereinafter, detailed description is made.

### “Trigger for Twice-Repeated Retraining Execution”

The processing apparatus 10 executes twice-repeated retraining according to a predetermined user input after outputting of recognition result text data after retraining.

The “predetermined user input after outputting of recognition result text data after retraining” may be, for example, a user input for starting retraining performed in a state where the same corrected text data as at a time of retaining are input. As one example, in a case where recognition result text data after retraining are displayed as in the output screen illustrated in FIG. 5 and FIG. 6, a “training” button is depressed again in a state where the same corrected text data as at a time of retraining are input in a corrected content field, and then the processing apparatus may execute twice-repeated retraining.

Note that, as described above, the processing apparatus 10 trains, at a time when a 10 speech recognition model is subjected to twice-repeated retraining, the speech recognition model by a method different from a method at a time of retraining. Therefore, at a time when the “training” button is depressed, it is necessary to decide whether retaining to be executed from now is “twice-repeated retraining”.

As one example for achieving this matter, the processing apparatus 10 may store, as retraining history data, corrected text data used in retraining so far (including retraining at a second time or later) and a content of a training method. The processing apparatus 10 can store the retaining history data in association with each piece of speech data to be recognized. Then, the processing apparatus 10 confirms, at a time when retaining is executed according to depression of the “training” button, whether corrected text data to be used for retaining this time are registered in retaining history data. In a case of being registered, the processing apparatus 10 makes decision as “twice-repeated retraining”, and executes retraining by a method different from a training method registered in the retaining history data. In contrast, in a case of being not registered, the processing apparatus 10 makes decision as “retraining”, and executes retaining by any method.

As another example of the “predetermined user input after outputting of recognition result text data after retraining”, the processing apparatus 10 may output, after displaying recognition result text data after retraining as in the output screen illustrated in FIG. 5 and FIG. 6, an inquiry message such as “Is an erroneously recognized part correctly corrected? Yes or No”. Then, in a case where an answer to the inquiry message is No, the processing apparatus 10 may execute twice-repeated retraining by using the same corrected text data as at a previous retaining.

“Function for training a speech recognition model by a method different from a method at a time of retraining”

The processing apparatus 10 trains, at a time of twice-repeated retraining, a speech recognition model by using learning data different from data at a time of retraining. More specifically, the processing apparatus 10 trains, at a time of twice-repeated retraining, a speech recognition model by using speech data (learning data) different from data at a time of retraining.

A sound data generation unit 15 generates, at a time of twice-repeated retraining, speech data (learning data) by a method different from a method at a time of retraining. The sound data generation unit 15 generates speech data (learning data) by a method different from a method at a previous time (retraining time), according to the predetermined user input after outputting of recognition result text data after retraining.

The sound data generation unit 15 may generate, at a time of twice-repeated retraining, for example, synthetic sound data uttering a content of corrected text data, by using a method different from a method at a time of retaining. Specifically, the sound data generation unit 15 may generate, at a time of twice-repeated retraining, a synthetic sound of an attribute different from an attribute (gender, an age group, an environment (outdoor, indoor, a phone, presence/absence of an echo, or the like), or the like) of a synthetic sound generated at a time of retraining.

In addition, the sound data generation unit 15 may cut out a part from speech data to be recognized acquired by an acquisition unit 11, and designate the cut part as retraining-use speech data. In this case, the sound data generation unit 15 needs to determine a part relevant to corrected text data in the speech data to be recognized acquired by the acquisition unit 11. A means that achieves this matter is not specifically limited, and every technique is employable. For example, from character string data in which recognition result text data are indicated by only hiragana or only katakana, character string data indicated by only hiragana or only katakana are retrieved based on pattern matching or the like, and utterance timing of the retrieved part may be detected in speech data to be recognized.

A training unit 14 executes again retraining (twice-repeated retraining) for a speech recognition model, by using learning data in which speech data (synthetic sound data generated by a method different from a method at a time of retraining, or retraining-use speech data generated by cutting out a part from speech data to be recognized) and corrected text data are associated with each other.

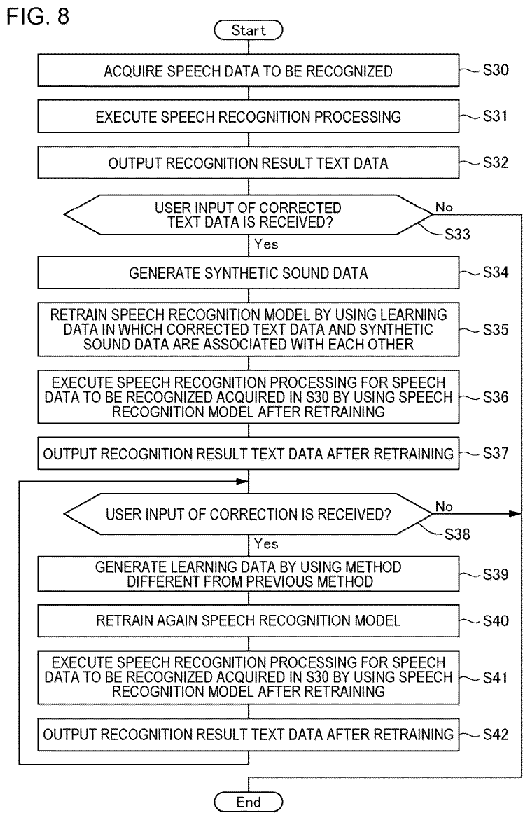

Next, by using a flowchart in FIG. 8, one example of a flow of processing of the processing apparatus 10 is described.

First, the processing apparatus 10 acquires speech data to be recognized (S30), and then executes speech recognition processing for the speech data to be recognized (S31). Specifically, the processing apparatus 10 inputs speech data to be recognized to a previously-prepared speech recognition model, and acquires recognition result text data indicating a content of the speech data to be recognized.

Next, the processing apparatus 10 outputs the recognition result text data indicating a result of the speech recognition processing for the speech data to be recognized (S32). The processing apparatus 10 outputs, for example, an output screen illustrated in FIG. 2.

Thereafter, the processing apparatus 10 receives a user input of corrected text data indicating a correct content of an erroneously recognized part included in the recognition result text data (Yes in S33), and then generates synthetic sound data uttering a content of the corrected text data (S34). Then, the processing apparatus 10 retrains the speech recognition model by using learning data in which the corrected text data and the synthetic sound data are associated with each other (S35).

Thereafter, the processing apparatus 10 executes speech recognition processing for the speech data to be recognized acquired in S30 by using the speech recognition model after subjected to retraining (S36). Specifically, the processing apparatus 10 inputs the speech data to be recognized acquired in S30 to the speech recognition model after subjected to retraining, and acquires recognition result text data after retraining indicating a content of the speech data to be recognized.

Next, the processing apparatus 10 outputs the recognition result text data after retraining (S37). The processing apparatus 10 executes, for example, processing of outputting the recognition result text data and the recognition result text data after retraining side by side as illustrated in FIG. 5, or processing of updating a content in a field for displaying a speech recognition result from the recognition result text data to the recognition result text data after retraining as illustrated in FIG. 6.

The processing apparatus 10 receives, after outputting the recognition result text data after retraining (after S37), a predetermined user input, and then generates speech data (learning data) by using a method different from a previous method (at a time of retraining) (S39). Then, the processing apparatus 10 retrains again the speech recognition model by using the learning data in which the corrected text data acquired in S33 and the speech data (learning data) generated in S39 are associated with each other (S40)

Thereafter, the processing apparatus 10 executes, by using the speech recognition model after subjected to retraining again, speech recognition processing for the speech data to be recognized acquired in S30 (S41). Specifically, the processing apparatus 10 inputs, to the speech recognition model after subjected to retraining again, the speech data to be recognized acquired in S30, and acquires recognition result text data after retraining indicating a content of the speech data to be recognized.

Next, the processing apparatus 10 outputs the recognition result text data after retraining (S42). The processing apparatus 10 may output, for example, side by side, a recognition result acquired by the speech recognition model after retraining and a recognition result acquired by the speech recognition model after twice-repeatedly retraining. In addition, the processing apparatus 10 may update a content in a field for displaying a speech recognition result from a recognition result acquired by the speech recognition model after retraining to the recognition result acquired by the speech recognition model after twice-repeatedly retraining. Also, in this case, the processing apparatus 10 may detect a difference point between the recognition result acquired by the speech recognition model after retraining and the recognition result acquired by the speech recognition model after twice-repeatedly retraining, and emphasize the detected difference point.

Another configuration of the processing apparatus 10 according to the present example embodiment is similar to that of the first to third example embodiments.

According to the processing apparatus 10 of the present example embodiment, an advantageous effect similar to that of the first to third example embodiments is achieved.

Further, according to the processing apparatus 10 of the present example embodiment, in a case where an erroneously recognized part is not correctly corrected by retraining a speech recognition model, the speech recognition model can be retrained again. Retraining of the speech recognition model is repeated, and thereby it is expected that an erroneously recognized part is correctly corrected.

Further, at a time of twice-repeated retraining, a speech recognition model can be retrained by a method different from a method at a time of retraining. Therefore, repetition of retaining of the speech recognition model can be more effective.

### Fifth Example Embodiment

A processing apparatus 10 according to the present example embodiment includes a function for determining an attribute of speech data to be recognized, and generating synthetic sound data including the determined attribute. Hereinafter, detailed description is made.

A sound data generation unit 15 determines an attribute of speech data to be recognized, and generates synthetic sound data including the determined attribute.

The sound data generation unit 15, for example, analyzes speech data to be recognized, and determines attribute information (an age group, gender, and the like) of a speaker, attribute information (outdoor, indoor, a phone, and the like) of an environment, and the like. The sound data generation unit 15 can determine these attributes by using a well-known technique. For example, a feature value relevant to each attribute is previously registered in the processing apparatus 10. Then, the sound data generation unit 15 detects a feature value relevant to each attribute in speech data to be recognized, and thereby, can determine an attribute of the speech data to be recognized.

Generation of synthetic sound data including a determined attribute can be achieved by using every well-known technique.

The processing apparatus 10 can perform, for example, in S24 in FIG. 7, S34 in FIG. 8, and the like, the above-described “determination of an attribute of speech data to be recognized, and generation of synthetic sound data including the determined attribute”. Note that, the processing apparatus 10 may perform, in S39 in FIG. 8, the above-described “determination of an attribute of speech data to be recognized, and generation of synthetic sound data including the determined attribute”.

Another configuration of the processing apparatus 10 according to the present example embodiment is similar to that of the first to fourth example embodiments.

According to the processing apparatus 10 of the present example embodiment, an advantageous effect similar to that of the first to fourth example embodiments is achieved.

Further, according to the processing apparatus 10 of the present example embodiment, synthetic sound data including the same attribute as in speech data to be recognized are generated, and thereby a speech recognition model can be retrained by using the synthetic sound data. As a result, based on the retraining, it is highly possible to correctly recognize an erroneously recognized part included in a speech recognition result of the speech data to be recognized.

### Modified Example

Herein, a modified example applicable to the first to fifth example embodiments is described.

A sound data generation unit 15 may generate synthetic sound data uttering a content of input corrected text data themselves, or may generate synthetic sound data uttering a content of modified corrected text data in which input corrected text data are modified.

Correction of input corrected text data can be performed by the sound data generation unit 15 (processing apparatus 10). The sound data generation unit 15 may generate, for example, in a case where a word is input as corrected text data, text including the input corrected text data, by using previously-prepared template text. As one example, in a case where a “typhoon” is input as corrected text data, the sound data generation unit 15 may generate text such as “A typhoon is moving north.”.

Also, in the modified example, an advantageous effect similar to that of the first to fifth example embodiments is achieved.

While, with reference to the accompanying drawings, the example embodiments according to the present invention have been described, the example embodiments are exemplification of the present invention, and various configurations other than the above-described configurations are employable. Configurations of the above-described example embodiments may be combined with each other, or a part of the configurations may be replaced with another configuration. Further, configurations according to the above-described example embodiments may be subjected to various changes within an extent without departing from the spirit of the present invention. Further, configurations and processing disclosed according to the above-described example embodiments and the above-described modified example may be combined with each other.

Further, in a plurality of flowcharts used in the above-described description, a plurality of steps (pieces of processing) are described in order, but execution order of steps to be executed according to each example embodiment is not limited to the described order. According to example embodiments, order of illustrated steps can be modified within an extent that there is no harm in context. Further, the above-described example embodiments can be combined within an extent that there is no conflict in content.

The whole or part of the example embodiments disclosed above can be described as, but not limited to, the following supplementary notes.
1. A processing apparatus including:
   an acquisition unit that acquires speech data to be recognized;
   a recognition unit that inputs the speech data to be recognized to a speech recognition model, and acquires recognition result text data indicating a content of the speech data to be recognized;
   an output unit that outputs the recognition result text data;
   a user input reception unit that receives a user input of corrected text data indicating a correct content of an erroneously recognized part included in the recognition result text data;
   a sound data generation unit that generates synthetic sound data uttering a content of the corrected text data; and
   a training unit that retrains the speech recognition model by using learning data in which the corrected text data and the synthetic sound data are associated with each other.
2. The processing apparatus according to supplementary note 1, wherein
   the recognition unit inputs the speech data to be recognized to the speech recognition model after subjected to the retraining, and acquires recognition result text data after retraining indicating a content of the speech data to be recognized, and
   the output unit outputs the recognition result text data after retraining.
3. The processing apparatus according to supplementary note 2, wherein
   the output unit executes
      processing of outputting the recognition result text data and the recognition result text data after retraining side by side, or
      processing of updating a content in a field for displaying a speech recognition result from the recognition result text data to the recognition result text data after retraining.
4. The processing apparatus according to supplementary note 2 or 3, wherein
   the output unit
      detects a different portion between the recognition result text data and the recognition result text data after retraining, and
      emphasizes the detected different portion in output of the recognition result text data after retraining.
5. The processing apparatus according to any one of supplementary notes 2 to 4, wherein
   the sound data generation unit
      generates again, based on a method different from a previous method, synthetic sound data uttering a content of the corrected text data according to a predetermined user input after outputting of the recognition result text data after retraining, and
   the training unit
      retrains again the speech recognition model by using learning data in which the corrected text data and the synthetic sound data generated again are associated with each other.
6. The processing apparatus according to any one of supplementary notes 2 to 4, wherein
   the sound data generation unit
      generates retraining-use speech data by cutting out a part from the speech data to be recognized according to a predetermined user input after outputting of the recognition result text data after retraining, and
   the training unit
      retrains again the speech recognition model by using learning data in which the corrected text data and the retraining-use speech data are associated with each other.
7. The processing apparatus according to any one of supplementary notes 1 to 6, wherein
   the sound data generation unit
      determines an attribute of the speech data to be recognized, and
      generates the synthetic sound data including the determined attribute.
8. The processing apparatus according to any one of supplementary notes 1 to 7, wherein
   the user input reception unit
      does not receive input for specifying the erroneously recognized part included in the recognition result text data.
9. A processing method including,
   by one or more computers:
      acquiring speech data to be recognized;
      inputting the speech data to be recognized to a speech recognition model, and acquiring recognition result text data indicating a content of the speech data to be recognized;
      outputting the recognition result text data;
      receiving a user input of corrected text data indicating a correct content of an erroneously recognized part included in the recognition result text data;
      generating synthetic sound data uttering a content of the corrected text data; and
      retraining the speech recognition model by using learning data in which the corrected text data and the synthetic sound data are associated with each other.
10. A program causing a computer to function as:
   an acquisition unit that acquires speech data to be recognized;
   a recognition unit that inputs the speech data to be recognized to a speech recognition model, and acquires recognition result text data indicating a content of the speech data to be recognized;
   an output unit that outputs the recognition result text data;
   a user input reception unit that receives a user input of corrected text data indicating a correct content of an erroneously recognized part included in the recognition result text data;
   a sound data generation unit that generates synthetic sound data uttering a content of the corrected text data; and
   a training unit that retrains the speech recognition model by using learning data in which the corrected text data and the synthetic sound data are associated with each other.

This application is based upon and claims the benefit of priority from Japanese patent application No. 2022-187196, filed on Nov. 24, 2022, the disclosure of which is incorporated herein in its entirety by reference.

### REFERENCE SIGNS LIST

10 Processing apparatus
11 Acquisition unit
12 Recognition unit
13 Output unit
14 Training unit
15 Sound data generation unit
16 User input reception unit
1A Processor
2A Memory
3A Input/output I/F
4A Peripheral circuit
5A Bus

What is claimed is:

1. A processing apparatus comprising:
at least one memory configured to store one or more instructions; and
at least one processor configured to execute the one or more instructions to:
acquire speech data to be recognized;
input the speech data to be recognized to a speech recognition model, and acquire recognition result text data indicating a content of the speech data to be recognized;
output the recognition result text data;
receive a user input of corrected text data indicating a correct content of an erroneously recognized part included in the recognition result text data;
generate synthetic sound data uttering a content of the corrected text data; and
retrain the speech recognition model by using learning data in which the corrected text data and the synthetic sound data are associated with each other.

2. The processing apparatus according to claim 1, wherein the at least one processor is further configured to execute the one or more instructions to
input the speech data to be recognized to the speech recognition model after subjected to the retraining, and acquire recognition result text data after retraining indicating a content of the speech data to be recognized, and
output the recognition result text data after retraining.

3. The processing apparatus according to claim 2, wherein the at least one processor is further configured to execute the one or more instructions to execute
processing of outputting the recognition result text data and the recognition result text data after retraining side by side, or
processing of updating a content in a field for displaying a speech recognition result from the recognition result text data to the recognition result text data after retraining.

4. The processing apparatus according to claim 2, wherein the at least one processor is further configured to execute the one or more instructions to
detect a different portion between the recognition result text data and the recognition result text data after retraining, and
emphasize the detected different portion in output of the recognition result text data after retraining.

5. The processing apparatus according to claim 2, wherein the at least one processor is further configured to execute the one or more instructions to
generate again, based on a method different from a previous method, synthetic sound data uttering a content of the corrected text data according to a predetermined user input after outputting of the recognition result text data after retraining, and
retrain again the speech recognition model by using learning data in which the corrected text data and the synthetic sound data generated again are associated with each other.

6. The processing apparatus according to claim 2, wherein the at least one processor is further configured to execute the one or more instructions to
generate retraining-use speech data by cutting out a part from the speech data to be recognized according to a predetermined user input after outputting of the recognition result text data after retraining, and
retrain again the speech recognition model by using learning data in which the corrected text data and the retraining-use speech data are associated with each other.

7. The processing apparatus according to claim 1, wherein the at least one processor is further configured to execute the one or more instructions to
determine an attribute of the speech data to be recognized, and
generate the synthetic sound data including the determined attribute.

8. The processing apparatus according to claim 1, wherein the at least one processor is further configured to execute the one or more instructions to
not receive input for specifying the erroneously recognized part included in the recognition result text data.

9. A processing method comprising,
by one or more computers:
acquiring speech data to be recognized;
inputting the speech data to be recognized to a speech recognition model, and acquiring recognition result text data indicating a content of the speech data to be recognized;
outputting the recognition result text data;
receiving a user input of corrected text data indicating a correct content of an erroneously recognized part included in the recognition result text data;
generating synthetic sound data uttering a content of the corrected text data; and
retraining the speech recognition model by using learning data in which the corrected text data and the synthetic sound data are associated with each other.

10. A non-transitory computer-readable medium storing a program causing a computer to:
acquire speech data to be recognized;
input the speech data to be recognized to a speech recognition model, and acquire recognition result text data indicating a content of the speech data to be recognized;
output the recognition result text data;
receive a user input of corrected text data indicating a correct content of an erroneously recognized part included in the recognition result text data;
generate synthetic sound data uttering a content of the corrected text data; and
retrain the speech recognition model by using learning data in which the corrected text data and the synthetic sound data are associated with each other.

11. The processing method according to claim 9, wherein the one or more computers
input the speech data to be recognized to the speech recognition model after subjected to the retraining, and acquire recognition result text data after retraining indicating a content of the speech data to be recognized, and
output the recognition result text data after retraining.

12. The processing method according to claim 11, wherein the one or more computers execute
processing of outputting the recognition result text data and the recognition result text data after retraining side by side, or
processing of updating a content in a field for displaying a speech recognition result from the recognition result text data to the recognition result text data after retraining.

13. The processing method according to claim 11, wherein the one or more computers
detect a different portion between the recognition result text data and the recognition result text data after retraining, and
emphasize the detected different portion in output of the recognition result text data after retraining.

14. The processing method according to claim 11, wherein the one or more computers
generate again, based on a method different from a previous method, synthetic sound data uttering a content of the corrected text data according to a predetermined user input after outputting of the recognition result text data after retraining, and
retrain again the speech recognition model by using learning data in which the corrected text data and the synthetic sound data generated again are associated with each other.

15. The processing method according to claim 11, wherein the one or more computers
generate retraining-use speech data by cutting out a part from the speech data to be recognized according to a predetermined user input after outputting of the recognition result text data after retraining, and
retrain again the speech recognition model by using learning data in which the corrected text data and the retraining-use speech data are associated with each other.

16. The non-transitory computer-readable medium according to claim 10, wherein the program causing the computer to
input the speech data to be recognized to the speech recognition model after subjected to the retraining, and acquire recognition result text data after retraining indicating a content of the speech data to be recognized, and
output the recognition result text data after retraining.

17. The non-transitory computer-readable medium according to claim 16, wherein the program causing the computer to execute
processing of outputting the recognition result text data and the recognition result text data after retraining side by side, or
processing of updating a content in a field for displaying a speech recognition result from the recognition result text data to the recognition result text data after retraining.

18. The non-transitory computer-readable medium according to claim 16, wherein the program causing the computer to
detect a different portion between the recognition result text data and the recognition result text data after retraining, and
emphasize the detected different portion in output of the recognition result text data after retraining.

19. The non-transitory computer-readable medium according to claim 16, wherein the program causing the computer to
generate again, based on a method different from a previous method, synthetic sound data uttering a content of the corrected text data according to a predetermined user input after outputting of the recognition result text data after retraining, and
retrain again the speech recognition model by using learning data in which the corrected text data and the synthetic sound data generated again are associated with each other.

20. The non-transitory computer-readable medium according to claim 16, wherein the program causing the computer to
generate retraining-use speech data by cutting out a part from the speech data to be recognized according to a predetermined user input after outputting of the recognition result text data after retraining, and
retrain again the speech recognition model by using learning data in which the corrected text data and the retraining-use speech data are associated with each other.
